(19) United States
(12) Patent Application Publication
(10) Pub. No.: US 2026/0318463 A1
(43) Pub. Date: Oct. 15, 2026

(54) PIPELINE SONAR VELOCITY, CONTROL, POSITION TRACKING, AND FLUID SLUG WARNING

(71) Applicant: Expro North Sea Limited, Aberdeenshire (GB)

(72) Inventors: Andrew MCNIEL, Crosby, TX (US); Andres Felipe ARANA, Youngsville, LA (US); Mohammed Amine OUHIBI, Aberdeen (GB)

(21) Appl. No.: 19/174,044

(22) Filed: Apr. 9, 2025

(51) Int. Cl. F16L 55/38; F16L 55/46; F16L 101/30; F17D 1/20; G01S 15/58

(52) U.S. Cl. CPC F16L 55/38; F16L 55/46; F17D 1/20; G01S 15/588; F16L 2101/30

(57) ABSTRACT

A method of measuring the velocity flow and tracking pipeline pig within a pipeline. The method includes deploying a pipeline pig within a pipeline segment of a pipeline. A pipeline flow velocity (PFV) of a fluid within the pipeline segment is measured using at least one flow meter coupled to the pipeline segment. The PFV of the fluid of the pipeline is provided to a controller or a user. The PFV of the fluid within the pipeline segment is compared to a velocity condition for operation of the pipeline pig. The operating settings of the pipeline are adjusted when the PFV does not meet the velocity condition for operation of the pipeline pig to maintain the velocity condition for operation of the pipeline pig.

### BACKGROUND

### Field

Embodiments of the present disclosure generally relate to flow meter technology to aid with general pigging activities and tracking. In particular, the present disclosure relates to maintaining pipeline flow velocity in order to meet general pigging velocity conditions, pig position tracking, and fluid slug warning.

### Description of the Related Art

Pipelines require regular inspection and testing to ensure its integrity and safety. Specialized tools, known as pigging tools, such as pigs or smart pigs, are used to perform the pipeline inspection. To effectively collect data, the smart pigs typically operate within a velocity range of between 3 feet per second and 10 feet per second. Prior to the smart pigs passing through the pipeline, cleaning pigs and gauging pigs are often utilized to ensure an internally clean pipeline, and often require the same velocity conditions between 3 feet per second and 10 feet per second. The most cost-effective method for propelling the pigs is to utilize the pipeline's production flow. If the pigs travel too quickly, the cleaning pigs may skip over dirt, debris, or contaminants and will not properly clean the pipeline, or the smart pigs may miss important details or data important to proving pipeline integrity. Conversely, if the pigs travel too slowly, the pigs are at risk of starting and stopping or may become stuck in the pipeline.

Currently, the most common method for tracking location and velocity of pipeline pigs uses RF transmitters placed inside the pig with RF receivers at specific points along the pipeline. However, RF tracking is typically performed by third parties and consists of multiple personnel and all-terrain vehicles along the pipeline to track the pig via the RF transmitters and receivers. The rough terrain and private properties rights of landowners in the regions where the pipeline is buried make these procedures inefficient and time consuming. In addition, the presence of a fluid slug and amount of fluid in the fluid slug

Therefore, there is a need for improved methods and systems for tracking pipeline pigs, detecting pipeline slugs, and controlling pipeline fluid velocity within the pipeline.

### SUMMARY

In one embodiment, a method is disclosed. The method includes deploying a pipeline pig within a pipeline segment of a pipeline. A pipeline flow velocity (PFV) of a fluid within the pipeline segment is measured using at least one flow meter coupled to the pipeline segment. The PFV of the fluid of the pipeline is provided to a controller or a user. The PFV of the fluid within the pipeline segment is compared to a velocity condition for operation of the pipeline pig. The operating settings of the pipeline are adjusted when the PFV does not meet the velocity condition for operation of the pipeline pig to maintain the velocity condition for operation of the pipeline pig.

In another embodiment, a method is disclosed. The method includes deploying a pipeline pig within a pipeline segment of a pipeline. One or more properties of a fluid within the pipeline segment are measured using at least one flow meter coupled to the pipeline segment. The one or more properties of the fluid are provided to a controller. The one or more properties of the fluid are analyzed to determine if there is a change in a fluid composition. The change in the fluid composition indicates a fluid slug. An audio/visual warning system is triggered to alert a pipeline operator of the fluid slug.

In yet another embodiment, a pipeline monitoring or cleaning system is disclosed. The system includes a pipeline segment of a pipeline, a pipeline upstream valve upstream of the pipeline segment, a pipeline downstream valve downstream of the pipeline segment, a pipeline pig launcher positioned upstream of the pipeline segment, a pipeline pig receiver positioned downstream of the pipeline segment an inlet line positioned between the pipeline upstream valve and the pipeline segment, an outlet line positioned between the pipeline segment and the pipeline downstream valve, one or more flow meters coupled to the pipeline segment and configured to measure a pipeline flow velocity (PFV) of a fluid within the pipeline, and a controller electronically coupled to the one or more flow meters. The controller is programmed to perform a method. The method includes deploying a pipeline pig within a pipeline segment of a pipeline. A pipeline flow velocity (PFV) of a fluid within the pipeline segment is measured using at least one flow meter coupled to the pipeline segment. The PFV of the fluid of the pipeline is provided to the controller.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, may admit to other equally effective embodiments.

FIG. 1 is a perspective view of a pipeline, according to embodiments of the present disclosure.

FIG. 2 depicts a flow meter, according to embodiments of the present disclosure.

FIG. 3 is a perspective view of a pipeline depicting a pipeline flow velocity datalogging (PFVD) configuration of the pipeline, according to embodiments of the present disclosure.

FIG. 4 depicts flow diagram of a method of operating the PFVD configuration of the pipeline, according to embodiments of the present disclosure.

FIG. 5 is a perspective view of a pipeline depicting a first automated pipeline rate assist (APRA) configuration of the pipeline, according to embodiments of the present disclosure.

FIG. 6 depicts a flow diagram of a method of operating the first APRA configuration of the pipeline, according to embodiments of the present disclosure.

FIG. 7 is a perspective view of a pipeline depicting a second APRA configuration of the pipeline, according to embodiments of the present disclosure.

FIG. 8 depicts a flow diagram of a method of operating the second APRA configuration of the pipeline, according to embodiments of the present disclosure.

FIG. 9 is a perspective view of a pipeline depicting a third APRA configuration of the pipeline, according to embodiments of the present disclosure.

FIG. 10 depicts a flow diagram of a method of operating the third APRA configuration of the pipeline, according to embodiments of the present disclosure.

FIG. 11 is a perspective view of a pipeline depicting a fluid slug early warning system (FSEWS) configuration of the pipeline, according to embodiments of the present disclosure.

FIG. 12 depicts a flow diagram of a method of operating the FSEWS configuration of the pipeline, according to embodiments of the present disclosure.

FIG. 13 is perspective view of a pipeline depicting a pipeline intervention gadget tracking (PIGT) configuration of the pipeline, according to embodiments of the present disclosure.

FIG. 14 is diagram depicting a controller, according to embodiments of the present disclosure.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Embodiments of the present disclosure generally relate to flow meter technology to aid with pipeline pig activities and tracking. In particular, the present disclosure relates to maintaining pipeline flow velocity in order to meet pipeline pig velocity conditions, pig position tracking, and fluid slug warning.

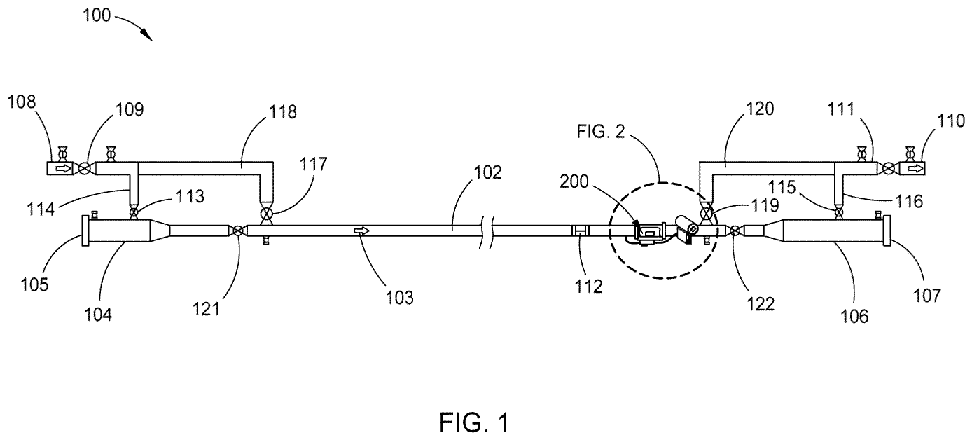

FIG. 1 is a perspective view of a pipeline 100 according to an embodiment of the present disclosure. The pipeline 100 includes a pipeline segment 102, a pipeline pig launcher 104 fluidically connected to the pipeline segment 102 along the length of the pipeline 100, pipeline pig receiver 106 fluidically connected to the pipeline 100 downstream of at least one pipeline pig launcher 104, and a flow meter 200 disposed on the pipeline 100. A fluid, such as a gas (e.g., natural gas), liquid product (e.g., a petroleum product, a liquid natural gas, etc.), or other liquid (water, slurry, drilling mud, etc.) flows through the pipeline segment 102 from a pipeline inlet segment 108 to a pipeline outlet segment 110 in flow direction 103. The fluid is introduced into the pipeline 100 via a pipeline inlet segment 108 when a pipeline upstream valve 109 is open. The fluid flows into the pipeline segment 102 via the inlet line 118 and the pipeline segment inlet valve 117 when the pipeline segment inlet valve 117 is open. During normal operation, the fluid enters the pipeline 100 via the pipeline inlet segment 108, flows through the pipeline upstream valve 109 and into the inlet line 118, and flows into the pipeline segment 102 via the pipeline segment inlet valve 117. The fluid exits the pipeline segment 102 via the pipeline segment outlet valve 119, and flows through the outlet line 120 when the pipeline segment outlet valve 119 is open. The fluid exits the pipeline 100 via a pipeline downstream valve 111 when the pipeline downstream valve 111 is open and flows out of the pipeline 100 through the pipeline outlet segment 110.

During pigging operations, a pipeline pig 112 is inserted into the pipeline segment 102 though a launch hatch 105 on the pipeline pig launcher 104. Once inserted, the launch hatch 105 is closed and fluid is diverted into the pipeline pig launcher 104. When open, a launch valve 113 enables the fluid from the inlet line 118 to divert to the launch line 114 to fill the pipeline pig launcher 104. The fluid within the pipeline 100 enters the pipeline 100 via the pipeline inlet segment 108 and flows into the launch line 114 via the pipeline upstream valve 109. The fluid flows into the pipeline pig launcher 104 from the launch line 114 via the launch valve 113. The pipeline segment inlet valve 117 is closed when the launch valve 113 is open. The diverted fluid fills the pipeline pig launcher 104 when the pipeline pig launcher valve 121 is closed. When the pipeline pig launcher 104 is full, the pipeline pig launcher valve 121 is opened and the pipeline pig 112 is launched into the pipeline segment 102 by the flow of the fluid through the pipeline pig launcher 104. The pipeline pig 112 travels through the pipeline segment 102 propelled by the fluid flowing in the pipeline 100, and collects data or performs cleaning operations as a smart pig or a cleaning pig, respectively. In some embodiments, the pipeline pig 112 operates best while moving through the pipeline at velocity conditions of about 3 ft/s and about 10 ft/s.

When a pipeline pig receiver valve 122 is open, the pipeline pig 112 and fluid enter the pipeline pig receiver 106. When open, a receiver valve 115 drains the fluid from the pipeline pig receiver 106 via the receiver line 116 and removes the fluid in the pipeline pig receiver 106 from the pipeline 100 via the pipeline outlet segment 110. The pipeline segment outlet valve 119 is closed and the pipeline downstream valve 111 is open when the receiver valve 115 is open. The pipeline pig 112 is removed from the pipeline segment 102 via the pipeline pig receiver 106. After removal of the pipeline pig 112, the pipeline segment outlet valve 119 is opened and the pipeline pig receiver valve 122 and the receiver valve 115 are closed to isolate the pipeline pig receiver 106 and divert fluid flow through the pipeline segment outlet valve 119. The pipeline pig 112 is removed from the pipeline pig receiver 106 when the fluid has been drained from the pipeline pig receiver 106. The pressure in the pipeline pig launcher 104 and the pipeline pig receiver 106 is bled using bleed or drain ports and valves before opening the launch hatch 105 or the receiver hatch 107. The pipeline pig launcher 104 and the pipeline pig receiver 106 bleed/drain paths often go to safe discharge like vent or flare or tank for liquids. The pipeline pig 112 is removed from the pipeline pig receiver 106 via the receiver hatch 107.

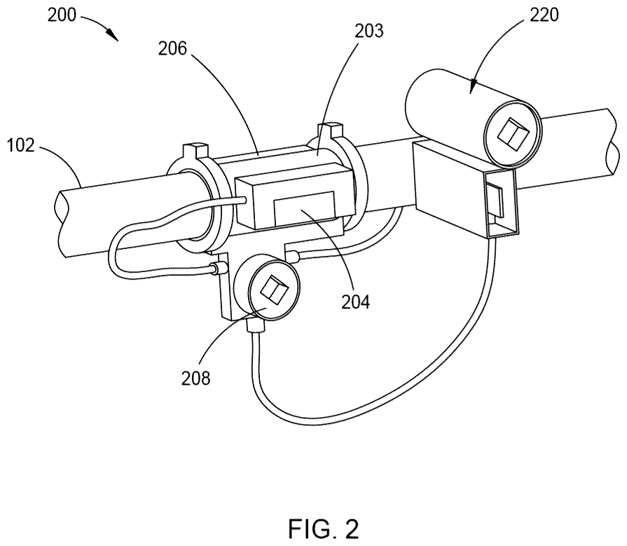

FIG. 2 depicts a flow meter 200 which can be used in embodiments of the present disclosure. The flow meter 200 may be positioned upstream of at least one pipeline pig receiver 106 on the pipeline segment 102, the inlet line 118, the launch line 114, or the pipeline inlet segment 108. In some embodiments, the flow meter 200 may be positioned downstream of the pipeline pig receiver 106 on the outlet line 120, the receiver line 116, or the pipeline outlet segment 110. In one example, the flow meter 200 is an active sonar meter, such as the ActiveSONAR flow meter from Expro. The flow meter 200 includes an annular body 203, a first transducer 204, a second transducer 206, a junction box 208, and a transmitter 220. The annular body 203 surrounds and secures the flow meter 200 to the pipeline segment 102. The first transducer 204 and second transducer 206 are located on diametrically opposite sides of the annular body 203. The first transducer 204 and the second transducer 206 are pulse-array transducers used to track the speed of the coherent flow structures within the pipeline segment 102. The flow meters 200 utilize pulsed sonar array processing techniques to measure the volumetric rate of the primary phase of liquid, gas, and multiphase flows. In another example, the flow meter 200 is a passive sonar meter, such as the PassiveSONAR flow meters from Expro. The passive sonar meter uses passive listening technology to determine the volumetric flow rate of the fluid within the pipeline 100. Sonar array processing techniques to listen to and interpret flow turbulence generated by fluid flow and sound generated by process piping and instrumentation. Existing active and passive sonar flow meters are typically used to measure the volumetric flow rate through pipelines. The pipeline flow velocity (PFV) of the fluid flowing through a pipeline segment 102 is measured by the flow meters 200 and is used to calculate the volumetric flow rate using the cross-sectional area of the pipeline segment 102 upon which the flow meter 200 is installed.

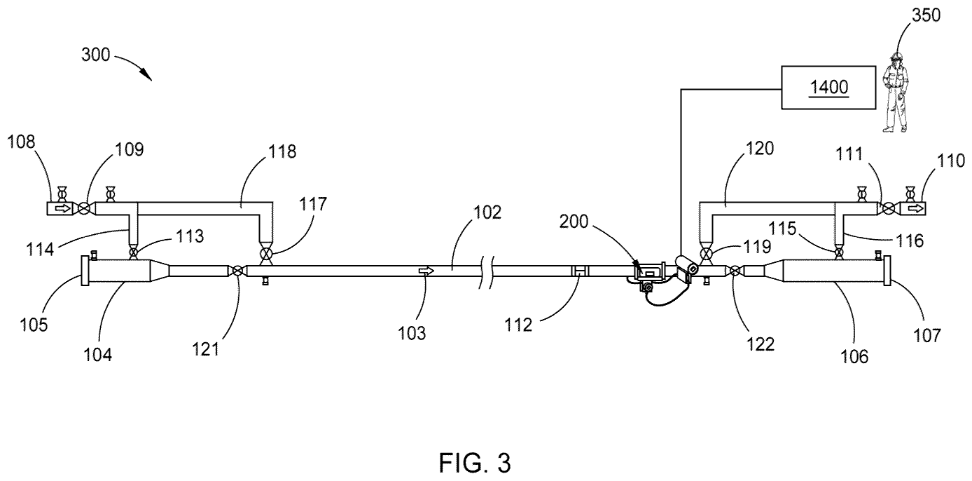

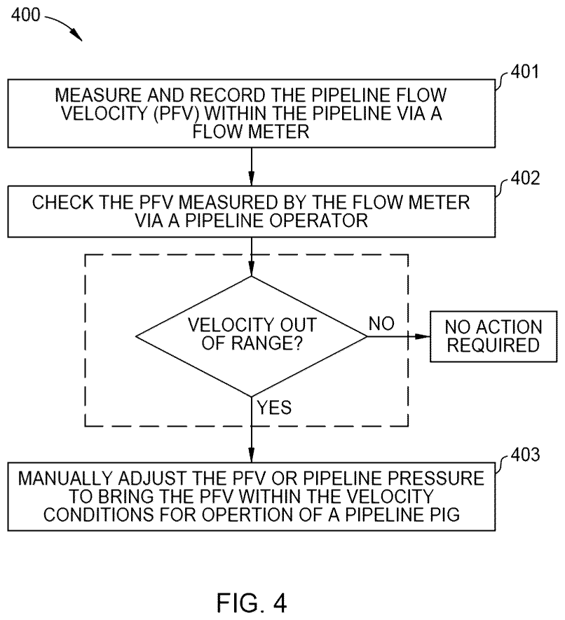

FIG. 3 is a perspective view of a pipeline system depicting a pipeline flow velocity datalogging (PFVD) configuration 300 within the pipeline segment 102. FIG. 4 depicts flow diagram of a method 400 of operating the PFVD configuration 300 of the pipeline 100. The PFVD configuration 300 utilizes at least one flow meter 200 to measure and record the pipeline flow velocity (PFV) within the pipeline segment 102. The PFV may be used by a pipeline operator 350 to manually adjust the flowrate within the pipeline segment 102 to sustain the pipeline pig 112 velocity conditions for operation.

At operation 401, the flow meter 200 measures and records the pipeline flow velocity (PFV) of the fluid within the pipeline segment 102. During operation 401, the pipeline pig 112 is deployed within the pipeline segment 102. The pipeline pig 112 is received in the pipeline pig launcher 104 of the pipeline 100 via a launch hatch 105 and deployed into the pipeline segment 102 via a pipeline pig launcher valve 121 when the pipeline pig launcher valve 121 is open. The pipeline pig 112 travels within the pipeline segment 102, gathering data or performing cleaning operations. To meet the velocity conditions for operation of the pipeline pig 112, a pressure differential is established from the pipeline inlet segment 108 to the pipeline outlet segment 110. The pressure differential may be established by opening and/or closing valves on the pipeline 100, (e.g., the pipeline upstream valve 109, the pipeline downstream valve 111, the pipeline segment inlet valve 117, and/or the pipeline segment outlet valve 119) or due to pressure loses or frictional losses from flowing the fluid through the pipeline 100.

At operation 402, the pipeline operator 350 checks the PFV measured by the flow meter 200. The pipeline operator 350 regularly checks the PFV readings coming from the flow meter 200. The pipeline operator 350 may physically monitor the pipeline 100 out in the field using a local controller (e.g., a computer or other smart technology), or receive the measurements from the flow meter 200 at a remote location via a display (e.g., a website with a real time data feed). The PFV readings are compared against the velocity conditions for operation of the pipeline pig 112. When the PFV within the pipeline segment 102 is within the velocity conditions for operation of the pipeline pig 112, no action is taken. When the PFV within the pipeline is greater than or less than the velocity conditions for operation of the pipeline pig 112, the method 400 progresses to operation 403.

At operation 403, the pipeline operator 350 manually adjusts the PFV, flow rate, or pressure within the pipeline segment 102 to bring the PFV within the velocity conditions for operation of the pipeline pig 112. The pipeline operator 350 may manually adjust the PFV out in the field or may adjust the PFV from a controller (e.g., a computer) remotely. The pipeline operator 350 may manually adjust the PFV by adjusting the pressure differential from the pipeline inlet segment 108 to the pipeline outlet segment 110. The pressure differential is adjusted by adjusting the valves on the pipeline 100 to create changes in the fluid pressure within the pipeline 100. The method 400 is repeated throughout operation of the pipeline 100. The pipeline pig 112 is removed from the pipeline 100 via a receiver hatch 107 of a pipeline pig receiver 106. The pipeline pig 112 is received in the pipeline pig receiver 106 via a pipeline pig receiver valve 122 when the pipeline pig receiver valve 122 is open.

By measuring and recording the PFV within the pipeline segment 102, the flow meter 200 provides feedback for flow control changes in order to achieve the PFV within the velocity conditions for operation of the pipeline pig 112. The ability to monitor and control the PFV within pipeline reduces the likelihood that the pipeline pigs 112 misses a measurement within or improperly cleans the pipeline segment 102.

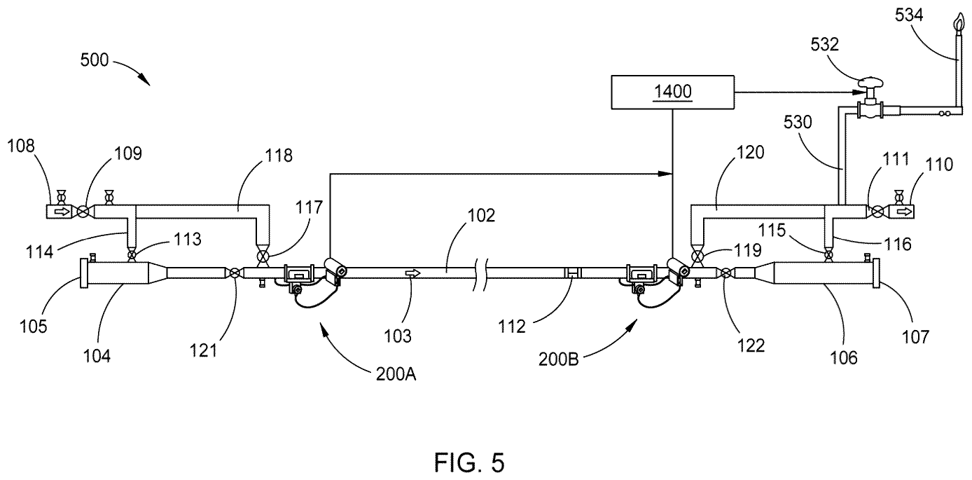

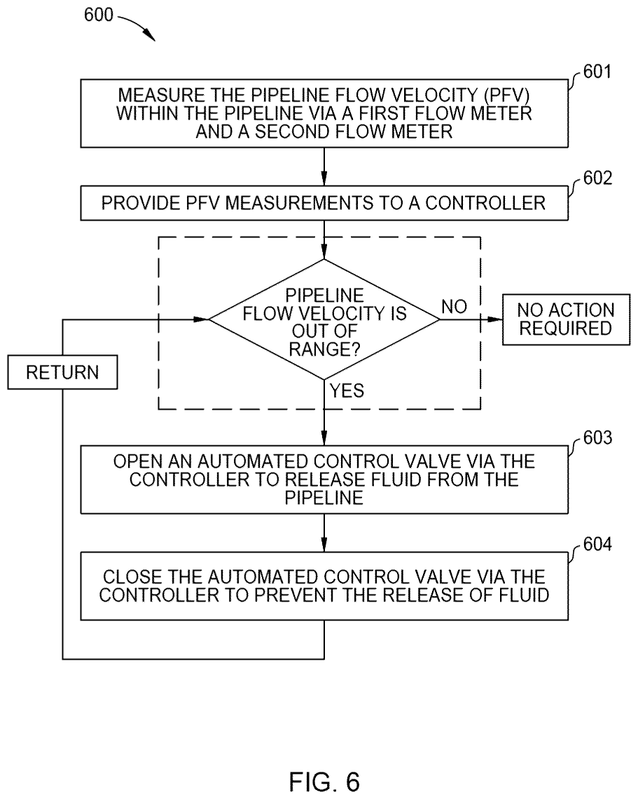

FIG. 5 is a perspective view of a pipeline system depicting a first automated pipeline rate assist (APRA) configuration 500 of the pipeline 100. FIG. 6 depicts a flow diagram of a method 600 of operating the first APRA configuration 500 of the pipeline 100. The first APRA configuration 500 utilizes at least one flow meter, such as a first flow meter 200A and a second flow meter 200B, to directly measure the pipeline flow velocity (PFV). The first flow meter and the second flow meter 200B are electrically coupled to a controller 1400. The PFV measurements are supplied to the controller 1400 from the first flow meter 200A and the second flow meter 200B. The controller 1400 controls the rate of a controlled release of fluid from the pipeline segment 102. In some embodiments, the controller 1400 controls the rate of a controlled release of fluid from the pipeline segment 102 to a flare 534 via a flare line 530. The flare line 530 may be positioned downstream of the outlet line 120 or may be positioned upstream of the pipeline segment inlet valve 117. The first APRA configuration 500 operates as a closed loop, so as the measured PFV changes, an automated control valve 532 is opened and closed by the controller 1400 to maintain velocity conditions for operation of the pipeline pig 112. By opening and closing the automated control valve 532, the flow area of the pipeline 100 may be changed, affecting the velocity, the fluid density, and other properties of the fluid within the pipeline 100.

At operation 601, the first flow meter 200A and the second flow meter 200B measure the pipeline flow velocity (PFV) of the fluid within the pipeline segment 102. During operation 601, the pipeline pig 112 is deployed within the pipeline segment 102. The pipeline pig 112 is received in a pipeline pig launcher 104 of the pipeline 100 via a launch hatch 105 and deployed into the pipeline segment 102 via a pipeline pig launcher valve 121 when the pipeline pig launcher valve 121 is open. The pipeline pig 112 travels within the pipeline segment 102, gathering data or performing cleaning operations. To meet the velocity conditions for operation of the pipeline pig 112, a pressure differential, flow rate, and flow velocity are established from the pipeline inlet segment 108 to the pipeline outlet segment 110.

At operation 602, the first flow meter 200A and the second flow meter 200B provide the PFV measurements to the controller 1400. The PFV measurements are compared against the velocity conditions for operation of the pipeline pig 112. When the PFV within the pipeline segment 102 is within the velocity conditions for operation of the pipeline pig 112, no action is taken. When the PFV within the pipeline segment 102 is less than the velocity conditions for operation of the pipeline pig 112, the method 600 progresses to operation 603.

At operation 603, the controller 1400 opens the automated control valve 532 to release fluid from the outlet line 120. In some embodiments, the automated control valve releases fluid from the outlet line 120 to the flare 534 via the flare line 530. The controller 1400 opens the automated control valve 532 by sending a permissive/control signal to the automated control valve 532. The automated control valve 532 is positioned downstream of the pipeline segment outlet valve 119 and upstream of the pipeline downstream valve 111. Releasing the fluid to the flare 534 increases the flow rate of the fluid through the pipeline segment 102 to bring the PFV within the velocity conditions for operation of the pipeline pig 112. The release of the fluid from the outlet line 120 to the flare 534 maintains the flowing pressure by creating more demand within the pipeline 100. The direct measurement of the PFV by the first flow meter 200A and the second flow meter 200B and the controller 1400 enable real time control of the PFV as the pipeline 100 experiences fluctuations in pressure or flow demands. This reduces the likelihood that these changes are overlooked or improperly addressed (i.e., slow reaction time from manual operators).

At operation 604, the controller 1400 closes the automated control valve 532 to prevent the release of fluid. The controller 1400 closes the automated control valve 532 by sending a permissive/control signal to the automated control valve 532. Once the velocity conditions for operation are met, the controller 1400 may partially close the automated control valve 532 to maintain the velocity conditions for operation. In some embodiments, if the PFV has surpassed the velocity conditions for operation, the controller 1400 may further close the automated control valve 532 to decrease the PFV to be within the velocity conditions for operation. Preventing the release of the fluid decreases the flowrate of the fluid through the pipeline segment 102, thereby increasing the pressure and decreasing the flow velocity of the fluid.

The method 600 is repeated throughout operation of the pipeline 100 under the first APRA configuration 500. As the controller 1400 closes the automated control valve 732 in operation 604 to decrease the fluid flow rate upstream of the inlet line 118, the flow velocity of the fluid within the pipeline will decrease. Once the flow velocity decreases below the velocity conditions for operation of the pipeline pig 112, as measured in operation 601, the PFV measurements provided to the controller 1400 in operation 602 will prompt the controller 1400 to open the automated control valve 532, releasing the fluid and increasing the fluid flow rate upstream of the inlet line 118 to bring the PFV within the velocity conditions for operation of the pipeline pig 112. The pipeline pig 112 is removed from the pipeline 100 via a receiver hatch 107 of a pipeline pig receiver 106. The pipeline pig 112 is received in the pipeline pig receiver 106 via a pipeline pig receiver valve 122 when the pipeline pig receiver valve 122 is open.

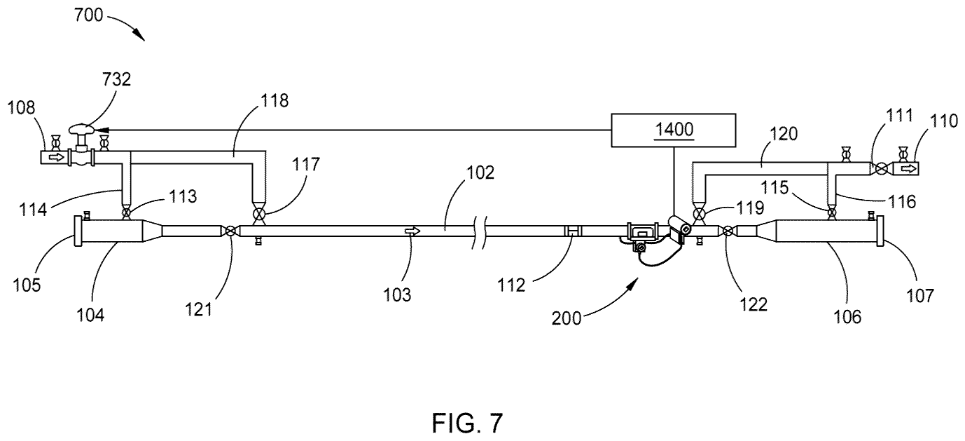

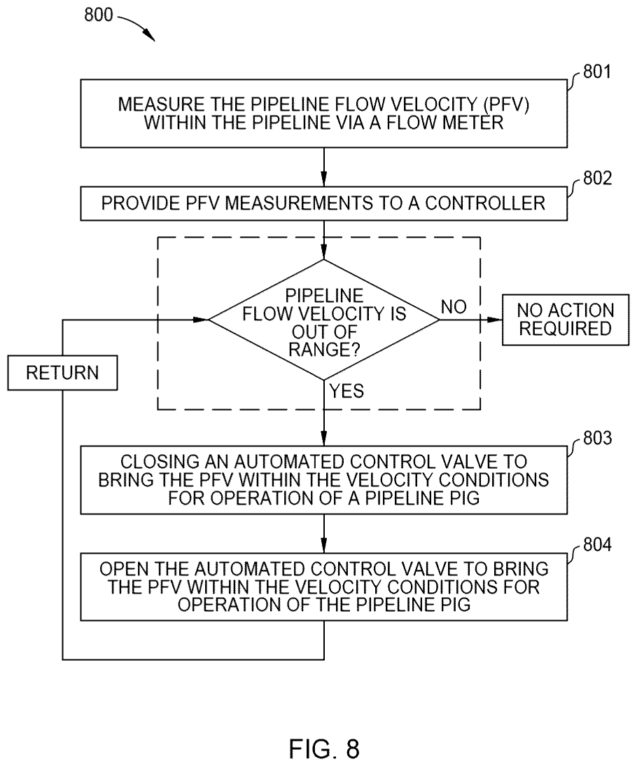

FIG. 7 is a perspective view of a pipeline system depicting a second automated pipeline rate assist (APRA) configuration 700 of the pipeline 100. FIG. 8 depicts a flow diagram of a method 800 of operating the second APRA configuration 700 of the pipeline 100. The second APRA configuration 700 utilizes at least one flow meter 200 to directly measure the pipeline flow velocity (PFV). The PFV measurements are supplied to a controller 1400 from the flow meter 200, which controls the flowrate upstream of the inlet line 118 via an automated control valve 732. In some embodiments, the automated control valve 732 is positioned downstream of the outlet line 120. In yet another embodiment, an automated control valve 732 is positioned both upstream of the inlet line 118 and downstream of the pipeline segment 102. By choking/limiting the fluid flowrate upstream and restricting the amount of fluid that enters the pipeline segment 102, the nominal flow demands downstream will continue to draw down the pressure in the pipeline segment 102, affecting the velocity, the fluid density, and other properties of the fluid within the pipeline 100. As the pressure decreases, the density of the fluid decreases and the velocity of the fluid increases. As the velocity of the fluid increases to maintain velocity conditions for operation of the pipeline pig 112, the controller 1400 may open the automated control valve 732 to increase the amount of fluid entering the pipeline segment 102 to stabilize the velocity conditions.

At operation 801, the flow meter 200 measures the pipeline flow velocity (PFV) of the fluid within the pipeline segment 102. During operation 801, the pipeline pig 112 is deployed within the pipeline segment 102. The pipeline pig 112 is received in a pipeline pig launcher 104 of the pipeline 100 via a launch hatch 105 and deployed into the pipeline segment 102 via a pipeline pig launcher valve 121 when the pipeline pig launcher valve 121 is open. The pipeline pig 112 travels within the pipeline segment 102, gathering data or performing cleaning operations. To meet the velocity conditions for operation of the pipeline pig 112, a pressure differential, flow rate, and flow velocity is established from the pipeline inlet segment 108 to the pipeline outlet segment 110.

At operation 802, the flow meter 200 provides the PFV measurements to the controller 1400. The PFV measurements are compared against the velocity conditions for operation of the pipeline pig 112. When the PFV within the pipeline segment 102 is within the velocity conditions for operation of the pipeline pig 112, no action is taken. When the PFV within the pipeline is less than the velocity conditions for operation of the pipeline pig 112, the method 800 progresses to operation 803.

At operation 803, the controller 1400 closes the automated control valve 732 to reduce the pressure downstream of the inlet line 118 and to bring the PFV within the velocity conditions for operation of the pipeline pig 112. The controller 1400 closes the automated control valve 732 by sending a permissive/control signal to the automated control valve 732. In the illustrated embodiment, the automated control valve 732 is positioned upstream of the pipeline segment inlet valve 117 and may replace the pipeline upstream valve 109. By reducing the flow rate upstream of the inlet line 118, the amount of fluid that enters the pipeline segment 102 is decreased. The decrease in the amount of fluid in the pipeline, coupled with continuing flow demand, leads to a decrease in pressure within the pipeline segment 102. As the pressure decreases, the density of the fluid decreases and the velocity of the fluid increases downstream in the pipeline segment 102. This condition is maintained until the velocity conditions for operation of the pipeline pig 112 are met.

At operation 804, the controller 1400 opens the automated control valve 732 to increase the pressure downstream of the inlet line 118 and to bring the PFV within the velocity conditions for operation of the pipeline pig 112. The controller 1400 opens the automated control valve 732 by sending a permissive/control signal to the automated control valve 732. In the illustrated embodiment, the automated control valve 732 is positioned upstream of the pipeline segment inlet valve 117 and may replace the pipeline upstream valve 109. By increasing the flow rate upstream of the inlet line 118, the amount of fluid that enters the pipeline segment 102 is increased. The increase in the amount of fluid in the pipeline 100 coupled with continuing downstream flow demand leads to an increase in pressure within the pipeline segment 102. As the pressure increases, the density of the fluid increases and the velocity of the fluid decreases in pipeline segment 102. This condition is maintained until the velocity conditions for operation of the pipeline pig 112 are met.

Once the velocity conditions for operation of the pipeline pig 112 are met, the controller 1400 may partially open the automated control valve 732 to increase the amount of fluid flowing entering the pipeline segment 102 and maintain the velocity conditions for operation. The increase in the amount of fluid may result in increasing the pressure, and increasing the fluid density, and decreasing the velocity of the fluid flow. In some embodiments, if the PFV has surpassed the velocity conditions for operation, the controller 1400 may further open the automated control valve 732 to decrease the PFV to be within the velocity conditions for operation.

The method 800 is repeated throughout operation of the pipeline 100 under the second APRA configuration 700. As the controller 1400 opens the automated control valve 732 in operation 804 to increase the pressure downstream of the inlet line 118, the flow velocity of the fluid within the pipeline will decrease. Once the flow velocity decreases below the velocity conditions for operation of the pipeline pig 112, as measured in operation 801, the PFV measurements provided to the controller 1400 in operation 802 will prompt the controller 1400 to close the automated control valve 732 in order to reduce the fluid flow rate upstream of the inlet line 118 and to bring the PFV within the velocity conditions for operation of the pipeline pig 112, per operation 803. The pipeline pig 112 is removed from the pipeline 100 via a receiver hatch 107 of a pipeline pig receiver 106. The pipeline pig 112 is received in the pipeline pig receiver 106 via a pipeline pig receiver valve 122 when the pipeline pig receiver valve 122 is open.

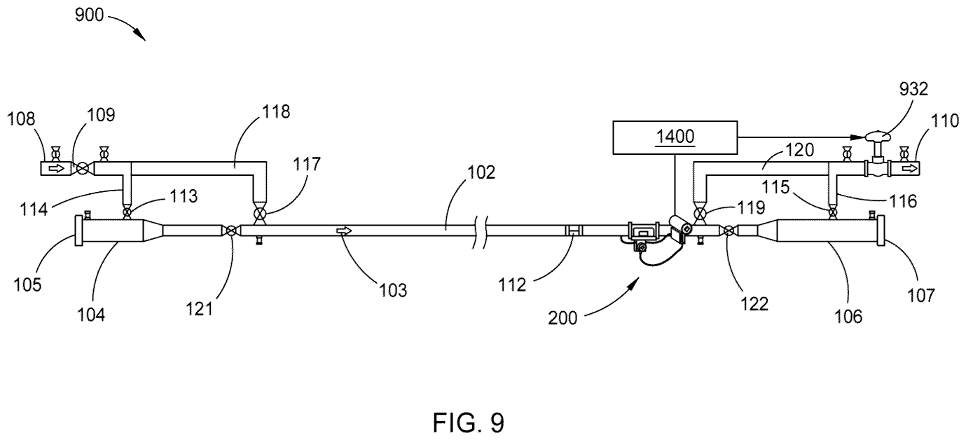

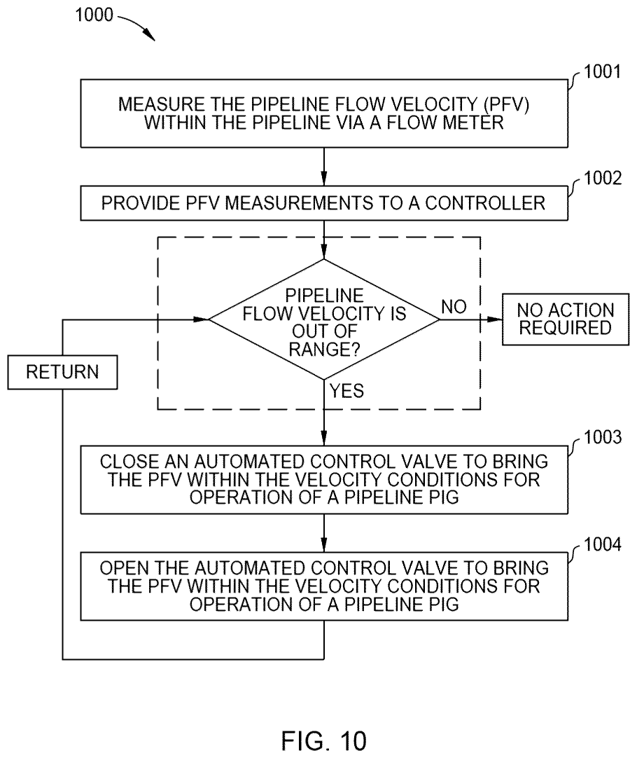

FIG. 9 is a perspective view of a pipeline system depicting a third automated pipeline rate assist (APRA) configuration 900 of the pipeline 100. FIG. 10 depicts a flow diagram of a method 1000 of operating the third APRA configuration 900 of the pipeline 100. The third APRA configuration 900 utilizes at least one flow meter 200 to directly measure the pipeline flow velocity (PFV). The PFV measurements are supplied to a controller 1400 from the flow meter 200, which controls the flowrate downstream of the outlet line 120 via an automated control valve 932. The automated control valve 932 may be positioned downstream of the outlet line 120 or may be positioned upstream of the pipeline segment inlet valve 117. By choking/limiting the amount of fluid downstream and restricting the amount of fluid that exits the pipeline segment 102, the nominal flow demands upstream will continue to increase the pressure in the pipeline segment 102, affecting the velocity, the fluid density, and other properties of the fluid within the pipeline 100. As the pressure within the pipeline segment 102 increases, the density of the fluid increases and the velocity of the fluid decreases. As the velocity of the fluid decreases to maintain velocity conditions for operation of the pipeline pig 112, the controller 1400 opens the automated control valve 732 to increase the amount of fluid exiting the pipeline segment 102.

At operation 1001, the flow meter 200 measures the pipeline flow velocity (PFV) of the fluid within the pipeline segment 102. During operation 1001, the pipeline pig 112 is deployed within the pipeline segment 102. The pipeline pig 112 is received in a pipeline pig launcher 104 of the pipeline 100 via a launch hatch 105 and deployed into the pipeline segment 102 via pipeline pig launcher valve 121 when the pipeline pig launcher valve 121 is open. The pipeline pig 112 travels within the pipeline segment 102, gathering data or performing cleaning operations. To meet the velocity conditions for operation of the pipeline pig 112, a pressure differential, flow rate, and flow velocity are established from the pipeline inlet segment 108 to the pipeline outlet segment 110.

At operation 1002, the flow meter 200 provide the PFV measurements to the controller 1400. The PFV measurements are compared against the velocity conditions for operation of the pipeline pig 112. When the PFV within the pipeline segment 102 is within the velocity conditions for operation of the pipeline pig 112, no action is taken. When the PFV within the pipeline is greater than the velocity conditions for operation of the pipeline pig 112, the method 1000 progresses to operation 1003.

At operation 1003, the controller 1400 closes the automated control valve 932 to reduce the fluid flowrate upstream of the inlet line 118 and to bring the PFV within the velocity conditions for operation of the pipeline pig 112. The controller 1400 closes the automated control valve 932 by sending a permissive/control signal to the automated control valve 932. In the illustrated embodiment, the automated control valve 932 is positioned downstream of the pipeline segment outlet valve 119 and may replace the pipeline upstream valve 109. By decreasing the flow rate upstream of the outlet line 120, the amount of fluid that enters the pipeline segment 102 is decreased. The decrease in the amount of fluid in the pipeline coupled with continuing downstream flow demand leads to a decrease in pressure within the pipeline segment 102. As the pressure decreases, the density of the fluid decreases and the velocity of the fluid increases in pipeline segment 102. This condition is maintained until the velocity conditions for operation of the pipeline pig 112 are met.

At operation 1004, the controller 1400 opens the automated control valve 932 to decrease the pressure downstream of the inlet line 118 and to bring the PFV within the velocity conditions for operation of the pipeline pig. The controller 1400 opens the automated control valve 932 by sending a permissive/control signal to the automated control valve 932. In the illustrated embodiment, the automated control valve 932 is positioned downstream of the pipeline segment outlet valve 119 and may replace the pipeline upstream valve 109. By increasing the flow rate upstream of the outlet line 120, the amount of fluid that enters the pipeline segment 102 is increased. The increase in the amount of fluid in the pipeline coupled with continuing downstream flow demand leads to an increase in pressure within the pipeline segment 102. As the pressure increases, the density of the fluid increases and the velocity of the fluid decreases in pipeline segment 102. This condition is maintained until the velocity conditions for operation of the pipeline pig 112 are met.

Once the velocity conditions for operation of the pipeline pig 112 are met, the controller 1400 may partially open the automated control valve 932 to increase the amount of fluid flowing exiting the pipeline segment 102 to maintain the velocity conditions for operation. The fluid within the pipeline segment 102 is at a decreased pressure, decreased density, and increased velocity. In some embodiments, if the PFV has decreased below the velocity conditions for operation, the controller 1400 may further open the automated control valve 932 to increase the PFV to be within the velocity conditions for operation.

The method 1000 is repeated throughout operation of the pipeline 100 under the third APRA configuration 900. As the controller 1400 opens the automated control valve 932 in operation 1004 to decrease the pressure upstream of the outlet line 120, the flow velocity of the fluid within the pipeline will increase. Once the flow velocity increases above the velocity conditions for operation of the pipeline pig 112, as measured in operation 1001, the PFV measurements provided to the controller 1400 in operation 1002 will prompt the controller 1400 to close the automated control valve 932 in order to reduce the fluid flow rate downstream of the outlet line 120 and to bring the PFV within the velocity conditions for operation of the pipeline pig 112, per operation 1003. The pipeline pig 112 is removed from the pipeline 100 via a receiver hatch 107 of a pipeline pig receiver 106. The pipeline pig 112 is received in the pipeline pig receiver 106 via a pipeline pig receiver valve 122 when the pipeline pig receiver valve 122 is open.

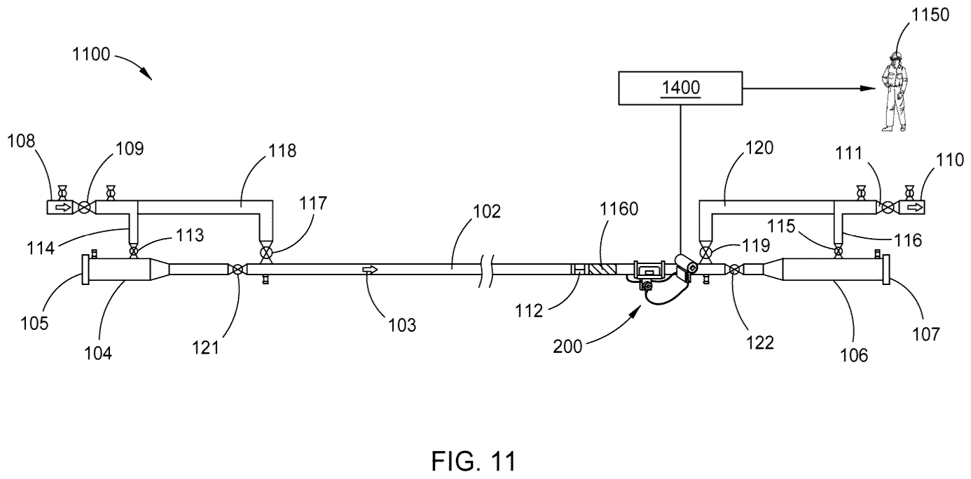

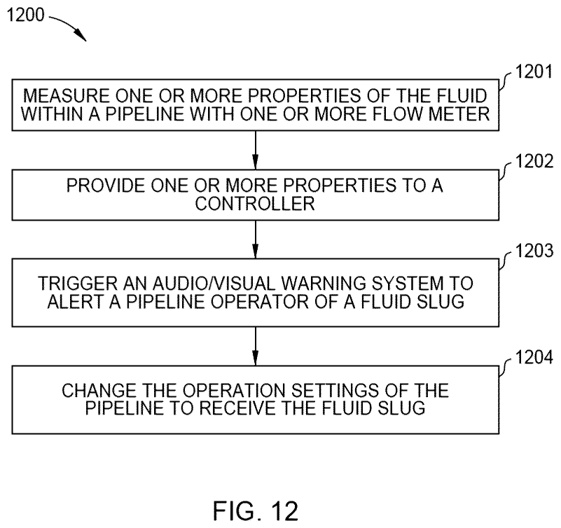

FIG. 11 is a perspective view of a pipeline system depicting a fluid slug early warning system (FSEWS) configuration 1100 of the pipeline 100. FIG. 12 depicts a flow diagram of a method 1200 of operating the FSEWS configuration 1100 of the pipeline 100. In some embodiments, the FSEWS configuration 1100 may be combined with the first APRA configuration 500, the second APRA configuration 700, or the third APRA configuration 900 to determine the location and velocity of the pipeline pig 112. Fluids are typically present in some quantity in low-lying areas of the pipeline segment 102. During cleaning operations of the pipeline pig 112, chemicals and other liquids are injected into the pipeline segment 102 to increase the effectiveness of the cleaning operation. The pipeline pig 112 collects and pushes these liquids in front the of pipeline pig 112, creating a fluid slug. The FSEWS configuration 1100 utilizes at least one flow meter 200 to directly measure the pipeline flow velocity (PFV) and outputs measurements for PFV, fluid velocity quality, fluid speed of sound, and fluid speed of sound quality of the fluids within the pipeline 100. The flow meter 200 detects phase changes in the base line reading that are measured by the flow meter 200. As the pipeline pig 112 approaches the flow meter 200 with the fluid slug, the fluid face will change as the flow meter 200 measures the properties of the fluid slug instead of the fluid. Once the flow meter 200 measures a phase change, causing the measurements to change significantly, the FSEWS configuration 1100 can trigger an alarm warning system to alert the operators of the presence of the pipeline pig 112 and the fluid slug. The phase change may be a complete phase change from liquid to gas, a change in the relative composition of liquid and gas, a change in the relative composition of two liquids, or a change in the relative composition of two gases.

Equipment located downstream of the segment of the pipeline segment 102 being cleaned, such as power plants, gas compressors, refineries, or petrochemical plants, may be sensitive to liquids. To protect the downstream equipment from the liquids in the fluid slug 1160, fluid flow is diverted from the pipeline segment 102 through a separator or the pipeline pig receiver 106 to prevent the fluid slug 1160 from traveling further downstream. While the pipeline pig 112 may be tracked in various ways, the fluid slug 1160 is not tracked because the exact amount of liquids is typically unknown and can arrive suddenly and without warning. The PFV measurements are supplied to a controller 1400 from the flow meter 200, which monitors the changes in flow regime from gas to liquid and alerts a pipeline operation 1150 of an impending fluid slug 1160 within through the pipeline segment 102. The pipeline operator 1150 may adjust the pipeline operation as needed to divert or capture the liquid in the fluid slug 1160 from continuing downstream.

At operation 1201, the flow meter 200 measures one or more properties of the fluid within the pipeline segment 102. The one or more properties output from the flow meter 200 include a pipeline flow velocity (PFV), the quality of the PFV, the speed of a fluid sound, and a speed of fluid sound quality (e.g., the confidence in the measurement by the flow meter) within the pipeline segment 102. During operation 1201, the pipeline pig 112 is deployed within the pipeline segment 102. The pipeline pig 112 is received in a pipeline pig launcher 104 of the pipeline 100 via a launch hatch 105 and deployed into the pipeline segment 102 via a pipeline pig launcher valve 121 when the pipeline pig launcher valve 121 is open. The pipeline pig 112 travels within the pipeline segment 102, gathering data or performing cleaning operations. Chemicals and other liquids may be injected into the pipeline segment 102 to increase the effectiveness of a cleaning operation of the pipeline pig 112, and may form a fluid slug 1160 within the pipeline segment 102.

At operation 1202, the flow meter 200 provide the one or more properties to the controller 1400. The one or more properties are analyzed to determine if there is a change in the fluid composition. When the measurements within the pipeline segment 102 indicate no changes in the fluid composition, no action is taken. When the measurements within the pipeline indicate changes in the fluid composition, the method 1200 progresses to operation 1203.

At operation 1203, the controller triggers an audio/visual warning system to alert the pipeline operator 1150. The audio/visual warning system outputs an audible or visual warning to the pipeline operation 1150 to alert the pipeline operator 1150 that a change in fluid composition is flowing through the pipeline segment 102, which may indicate the presence of a fluid slug 1160 and the pipeline pig 112. The pipeline operator 1150 may analyze the change in fluid composition to determine if a fluid slug 1160 is present.

At operation 1204, the pipeline operator 1150 changes the operation settings of the pipeline segment 102 to receive the fluid slug 1160. If the pipeline operator 1150 determines that a fluid slug 1160 is present, the pipeline operator 1150 may prepare the pipeline pig receiver 106 of the pipeline 100 to receive the fluid slug 1160. In some embodiments, the fluid slug 1160 may be received using the pipeline pig receiver 106 by opening a pipeline pig receiver valve 122. In other embodiments, the fluid slug 1160 may be diverted and received in a separator or other process equipment.

The method 1200 is repeated throughout operation of the pipeline 100 under the FSEWS configuration 1100. The pipeline pig 112 is removed from the pipeline 100 via a receiver hatch 107 of a pipeline pig receiver 106. The pipeline pig 112 is received in the pipeline pig receiver 106 via a pipeline pig receiver valve 122 when the pipeline pig receiver valve 122 is open.

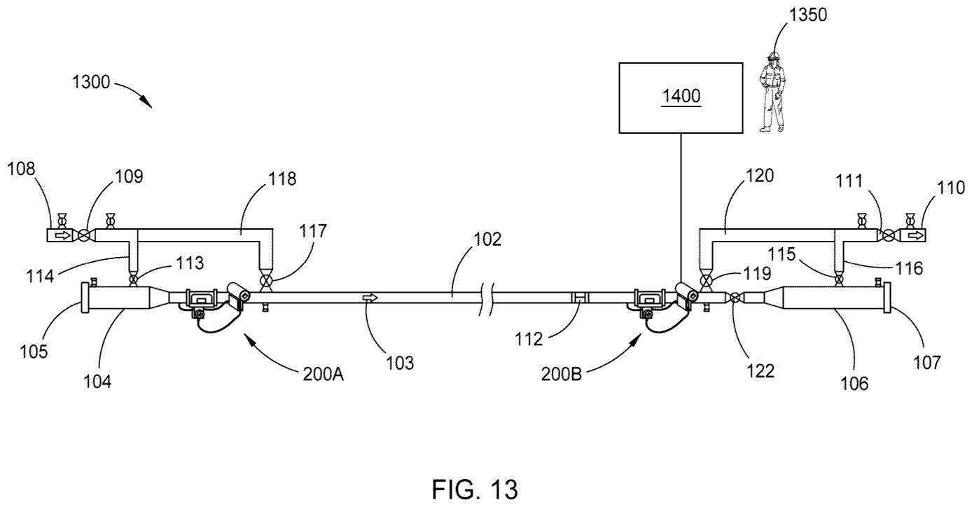

FIG. 13 is a perspective view of a pipeline system depicting a pipeline intervention gadget tracking (PIGT) configuration 1300 of the pipeline 100. Tracking the location of the pipeline pig 112 (e.g., a smart pig) within a pipeline assists pipeline operators 1350 with receiving the pipeline pig 112 by bringing certain equipment online. In addition, tracking the location of the pipeline pig 112 enables velocity verification to ensure that the pipeline pig 112 maintains the velocity conditions for operation. If the pipeline pig 112 becomes stuck within the pipeline segment 102, knowing the specific location of the pipeline pig 112 enables the pipeline operators 1350 to shut down, dig up, cut into, and recover the pipeline pig 112 efficiently to avoid excess down time. The PIGT configuration 1300 may include at least one flow meter. A first flow meter 200A may be attached to the pipeline pig launcher 104 upstream of pipeline pig launcher valve 121 and a second flow meter 200B may be attached to the pipeline segment 102 upstream of the pipeline pig receiver valve 122 and pipeline segment outlet valve 119.

The PIGT configuration 1300 utilizes at least the first flow meter 200A and the second flow meter 200B to directly measure the pipeline flow velocity (PFV). The PFV measurements are supplied to a controller 1400 from the first flow meter 200A and the second flow meter 200B to predict the location and velocity of the pipeline pig 112 within the pipeline segment 102. The location prediction is performed through a calculation, performed by the controller 1400 of the PIGT configuration 1300, using velocity output from the flow meters (and other operational factors such as compressibility and friction factors). The controller 1400 calculates the distance traveled from the pipeline pig launcher 104 using the process flow velocity. The distance traveled can be displayed via the controller 1400 to an operator using a number, a diagram, or a map to show the estimated pipeline pig 112 location. In one embodiment, the estimated pipeline pig 112 location can be displayed using Expro's EdgeX system. In other embodiments, other data systems and live data streaming services may be used. In some embodiments, the EdgeX system may incorporate Data to Desk functionality for data transfer from the field system to the Expro servers, and then transfer the data and pipeline pig 112 tracking live through the Data to Desk website. In some embodiments, when a pipeline segment 102 includes flowing tees or laterals, more than two flow meters may be used to accurately predict the location and velocity of the pipeline pig 112.

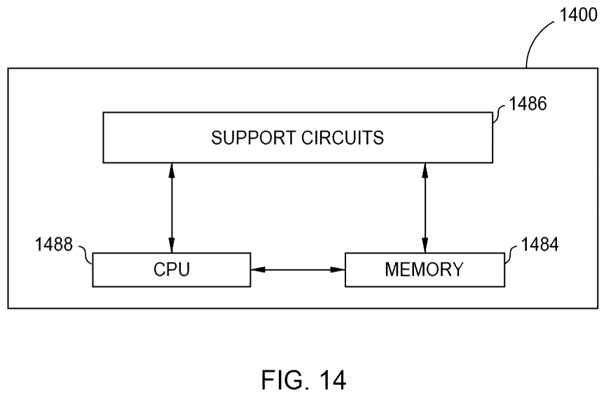

FIG. 14 is a diagram depicting a controller 1400. The controller 1400 is configured to receive data or input from the pipeline 100. The controller includes a memory 1484, support circuits 1486, and a central processing unit (CPU) 1488 (e.g., a processor) that are coupled to one another. The controller 1400 controls various components of the pipeline 100 directly, or via other computers and/or controllers.

The CPU 1488 is any form of general purpose computer processor that is used in an industrial setting for controlling the pipeline 100, such as a programmable logic controller (PLC), supervisory control and data acquisition (SCADA) systems, general purpose graphics processing unit (GPU), or other suitable industrial controller. A software, such as Expro EdgeX, may be used to program the CPU 1488 to enable displays and set control parameters. The memory 1484, or non-transitory computer readable medium, is one or more of a readily available memory such as random access memory (RAM), dynamic random access memory (DRAM), static RAM (SRAM), and synchronous dynamic RAM (SDRAM) (e.g., DDR1, DDR2, DDR3,DDRL3, LPDDR3, DDR4, LPDDR4, and the like)), read only memory (ROM), floppy disk, hard disk, flash drive, or any other form of digital storage, local or remote. The support circuits 1486 of the controller 1400 are coupled to the CPU 1488 for supporting the CPU 1488. The support circuits 1486 include cache, power supplies, clock circuits, input/output circuitry and subsystems, and the like. The input/output circuitry may include a control box on a valve of the pipeline 100 or an alarm system.

The memory 1484 contains instructions that, when executed by the CPU 1488, facilitates execution of the configurations 300, 500, 700, 900, 1100, or 1300. The instructions in the memory 1484 are in the form of a program product such as a program that implements the method of the present disclosure. The program code of the program product may conform to any one of a number of different programming languages.

Operational parameters and operations are stored in the memory 1484 as a software routine that is executed or invoked. The controller 1400 is configured to conduct any of the operations described herein. The instructions stored on the memory 1484, when executed, cause one or more of the operations (such as the operations of methods 400, 600, 800, 1000, or 1200) described herein to be conducted in relation to the pipeline 100.

The various operations described herein can be conducted automatically using the controller 1400, or can be conducted automatically or manually with certain operations conducted by a user.

In summary, pipelines require regular maintenance and testing to ensure their integrity and safety. This inspection and testing is performed using pipeline pigs that are inserted into the pipeline and propelled by fluid flow within the pipeline. For effective measurement and cleaning operations, the pipeline pigs must operate within a specific velocity range. Flow meters installed on the pipeline can measure the velocity of the fluid flow within the pipeline to determine the velocity and position of the pipeline pig within the pipeline. The flow meters can be coupled with pipeline operators or controllers to adjust the operational settings of the pipeline to maintain the velocity conditions for operation of the pipeline pig. In addition, the flow meters can determine whether a fluid slug has formed within the pipeline and alert the pipeline operator to take appropriate action. Finally, the flow meters may be utilized to track the pipeline pig within the pipeline to accurately determine the location of the pipeline pig in the event the pipeline pig is stuck within the pipeline, enabling more efficient recovery of the pipeline pig.

While the foregoing is directed to embodiments of the present disclosure, other and further embodiments of the disclosure may be devised without departing from the basic scope thereof, and the scope thereof is determined by the claims that follow.

What is claimed is:

1. A method, comprising:
deploying a pipeline pig within a pipeline segment of a pipeline;
measuring a pipeline flow velocity (PFV) of a fluid within the pipeline segment using at least one flow meter coupled to the pipeline segment;
providing the PFV of the fluid of the pipeline;
comparing the PFV of the fluid within the pipeline segment to a velocity condition for operation of the pipeline pig; and
adjusting operating settings of the pipeline when the PFV does not meet the velocity condition for operation of the pipeline pig to maintain the velocity condition for operation of the pipeline pig.

2. The method of claim 1, further comprising measuring of the PFV using an active sonar flow meter or a passive sonar flow meter.

3. The method of claim 1, further comprising:
providing the PFV to a controller, the controller comprising:
a memory;
support circuits; and
a central processing unit; and
adjusting the operating settings of the pipeline when the PFV does not meet the velocity condition for operation of the pipeline pig via the controller.

4. The method of claim 3, further comprising:
opening an automated control valve positioned downstream of the pipeline segment via the controller when the PFV of the fluid within the pipeline segment is lower than the velocity condition for operation of the pipeline pig;
releasing the fluid from the pipeline via the automated control valve to increase the PFV of the fluid within the pipeline to the velocity condition for operation of the pipeline pig; and
closing the automated control valve via the controller to prevent the release of fluid when the PFV of the fluid within the pipeline segment is higher than the velocity condition for operation of the pipeline pig.

5. The method of claim 3, further comprising:
closing an automated control valve positioned upstream of a pipeline segment via the controller when the PFV of the fluid within the pipeline segment is lower than the velocity condition for operation of the pipeline pig to increase the PFV of the fluid within the pipeline segment to the velocity condition for operation of the pipeline pig; and
opening the automated control valve via the controller to decrease the PFV in the pipeline segment when the PFV of the fluid within the pipeline segment is higher than the velocity condition for operation of the pipeline pig.

6. The method of claim 3, further comprising:
closing an automated control valve positioned downstream of a pipeline segment via the controller when the PFV of the fluid within the pipeline segment is greater than the velocity condition for operation of the pipeline pig to reduce the PFV of the fluid within the pipeline segment to the velocity condition for operation of the pipeline pig; and
opening the automated control valve to increase the PFV in the pipeline segment when the PFV of the fluid within the pipeline segment is lower than the velocity condition for operation of the pipeline pig.

7. The method of claim 1, further comprising:
loading the pipeline pig in a pipeline pig launcher of the pipeline via a launch hatch, wherein the pipeline pig launcher is in fluid communication with the pipeline segment; and
deploying the pipeline pig into the pipeline segment via a launch valve.

8. The method of claim 7, further comprising:
receiving the pipeline pig in a pipeline pig receiver via a receiver valve in fluid communication with the pipeline segment, wherein the pipeline pig receiver is downstream of the pipeline pig launcher; and
removing the pipeline pig from the pipeline segment via a catch hatch of the pipeline.

9. The method of claim 1, further comprising performing data collection or a cleaning operation with the pipeline pig.

10. The method of claim 1, further comprising adjusting operating settings of the pipeline to maintain the velocity condition for operation of the pipeline pig from about 3 ft/sec to about 10 ft/sec.

11. A method, comprising:
deploying a pipeline pig within a pipeline segment of a pipeline
measuring one or more properties of a fluid within the pipeline segment using at least one flow meter coupled to the pipeline segment;
providing the one or more properties of the fluid to a controller;
analyzing the one or more properties of the fluid to determine if there is a change in a fluid composition, wherein the change in the fluid composition indicates a fluid slug; and
trigger an audio/visual warning system to alert a pipeline operator of the fluid slug.

12. The method of claim 11, further comprising:
changing operation settings of the pipeline or processing equipment to receive the fluid slug; and
removing the fluid slug from the pipeline segment, wherein removing the fluid slug comprises diverting the fluid slug to a separator or slug catcher.

13. The method of claim 12, wherein removing the fluid slug comprises diverting the fluid slug into a pipeline pig receiver via a receiver valve positioned downstream of the pipeline.

14. The method of claim 11, wherein the fluid slug comprises injecting chemicals for performing a cleaning operation with the pipeline pig into the pipeline segment.

15. The method of claim 11, wherein measuring one or more properties of a fluid comprises:
measuring a pipeline flow velocity (PFV);
measuring a quality of the PFV;
measuring a speed of a fluid sound; and
measuring a fluid sound quality within the pipeline.

16. A pipeline monitoring or cleaning system, comprising:
a pipeline segment of a pipeline;
a pipeline upstream valve upstream of the pipeline segment;
a pipeline downstream valve downstream of the pipeline segment;
a pipeline pig launcher positioned upstream of the pipeline segment;
a pipeline pig receiver positioned downstream of the pipeline segment;
an inlet line positioned between the pipeline upstream valve and the pipeline segment;
an outlet line positioned between the pipeline segment and the pipeline downstream valve;
one or more flow meters coupled to the pipeline segment and configured to measure a pipeline flow velocity (PFV) of a fluid within the pipeline; and
a controller electronically coupled to the one or more flow meters, the controller programmed to perform a method comprising:
deploying a pipeline pig within a pipeline segment of a pipeline
measuring a pipeline flow velocity (PFV) of a fluid within the pipeline segment using at least one flow meter coupled to the pipeline segment; and
providing the PFV of the fluid of the pipeline to the controller.

17. The pipeline monitoring or cleaning system of claim 16, wherein controller is programmed to calculate and predict a location and a velocity of a pipeline pig within the pipeline segment using the PFV measured by the one or more flow meters.

18. The pipeline monitoring or cleaning system of claim 16, wherein the controller is programmed to perform the method further comprising:
comparing the PFV of the fluid within the pipeline segment to a velocity condition for operation of a pipeline pig; and
adjusting the operation settings of the pipeline to maintain a velocity condition for operation of the pipeline pig.

19. The pipeline monitoring or cleaning system of claim 18, wherein the controller is programmed to adjust the operation settings of the pipeline to maintain a velocity of the pipeline pig from about 3 ft/sec and about 10 ft/sec.

20. The pipeline monitoring or cleaning system of claim 16, wherein the controller is programmed to:
determine if there is a change in a fluid composition within the pipeline, wherein the change in the fluid composition indicates a fluid slug; and
trigger an audio/visual warning system to alert a pipeline operator of the fluid slug.
